(19) United States
(12) Patent Application Publication
(10) Pub. No.: US 2008/0273124 A1
(43) Pub. Date: Nov. 6, 2008

(54) Liquid crystal display apparatus and liquid crystal television

(75) Inventor: Yoshihiro Ogino, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 12/150,354

(22) Filed: Apr. 28, 2008

(30) Foreign Application Priority Data
May 1, 2007 (JP) JP2007-120707

(51) Int. Cl. G09G 3/36; G02F 1/13357; H04N 3/14

(52) U.S. Cl. 348/790; 345/102

(57) ABSTRACT

The present invention discloses a liquid crystal display apparatus and a liquid crystal television that control the lighting of the backlight to reduce the power consumption and inform the user that the lighting is controlled while no video signal is inputted, enabling to realize the energy saving without impairing the user's convenience. When the microcomputer detects that no video signal is inputted, it stabilizes the oscillation duty ratio of the control circuit 32c at an oscillation frequency lower than a predetermined value by decreasing the duty ratio of the brightness control signal inputted in the control circuit 32c and by shifting the feedback tube current Isen that is feedbacked from the tube current feedback circuit 32f to the high current side.

### CROSS-REFERENCES TO RELATED APPLICATIONS

The present application is related to the Japanese Patent Application No. 2007-120707, filed May 1, 2007, the entire disclosure of which is expressly incorporated by reference herein.

### BACKGROUND OF THE INVENTION

1. Field of the Invention

The present invention relates to a liquid crystal display apparatus and a liquid crystal television, more particularly, to a liquid crystal display apparatus and a liquid crystal television that includes a separately-excited inverter circuit in which a feedback control is performed using the tube current value for a backlight.

2. Description of the Related Art

In a liquid crystal display apparatus such as a liquid crystal television, a backlight is required as a light source. An electric discharge lamp such as a cold-cathode tube is often used for this backlight. The power consumption of this backlight using an electric discharge lamp occupies more than a half of the total power consumption of a liquid crystal television. In addition, basically, the brightness of a liquid crystal television is adjusted not by changing the amount of light of the backlight but by using the aperture ratio of the liquid crystal cell. For this reason, even when displaying no images, the backlight is lit with the same amount of light as required when displaying an image, wasting unnecessary electric power for the backlight.

For such a problem, Japanese Unexamined Patent Application Publication No. 2006-13942 discloses an invention, wherein it prevents the unnecessary electric power of the backlight from wasting by turning off a part of backlight if no video signal from an external input terminal is inputted for a given length of time, accomplishing electric power saving.

Also, Japanese Unexamined Patent Application Publication No. Hei7 (1995)-13128 discloses an invention in the self-excitation inverter circuit, wherein it changes the duty of pulses applied to a fluorescent tube by enabling the direct current supply to turn on/off using a switching device and by changing the on/off duty ratio of the switching device, that is to say, it controls the brightness of a fluorescent tube by changing the effective value of the tube current.

In the meantime, many liquid crystal display apparatuses have a function to inform the user of a state of no video signal is inputted by on-screen displaying “No Signal” for example. This function demands at least the electric discharge lamp where this indication is displayed continues to be lit. According to the technique of Japanese Unexamined Patent Application Publication No. 2006-13942, two kinds of electric discharge lamps are caused to be generated: one functioning to turn off while no video signal is inputted and the other functioning to continue to light while no video signal is inputted, resulting in that unevenness is generated in the lifetime of the electric discharge lamp. In addition, the technology disclosed in Japanese Unexamined Patent Application Publication No. Hei7 (1995)-13128 is for the self-excitation inverter circuit, and is difficult to apply it to the separately-excited inverter circuit.

### BRIEF SUMMARY OF THE INVENTION

The present invention aims at providing a liquid crystal display apparatus and a liquid crystal television equipped with a separately-excited inverter circuit that can control the lighting of backlight so as to reduce the power consumption while no video signal is inputted, inform a user of the state of controlling lighting, and save the energy without impairing the user's convenience.

The present invention discloses a liquid crystal display apparatus, comprising: a separately-excited inverter circuit having a control circuit that changes an oscillation duty ratio of secondary voltage of the separately excited inverter circuit so that a feedback tube current feedbacked from a secondary side of the separately-excited inverter circuit becomes a predetermined value corresponding to a brightness control signal that is input to the separately excited inverter circuit; a plurality of the electric discharge lamps that are activated by an AC voltage generated by the separately-excited inverter circuit; a liquid crystal panel, with each liquid crystal cell driven by a drive signal generated from a video signal, lights of the electric discharge lamps are illuminated from the back surface of the liquid crystal panel, and an image is displayed on screen; and a signal input decision unit that determines if a video signal is inputted and, if the signal input decision unit determines that no video signal is inputted, the signal input decision unit displays a message indicating that no video signal is input on the liquid crystal panel, the liquid crystal display apparatus, further comprising: a tube current control unit that stabilizes the oscillation duty ratio of the control unit at an oscillation frequency lower than a predetermined value corresponding to the tube current of an electric discharge lamp by changing the brightness control signal inputted in the control circuit, which decreases the duty ratio and by raising the feedback tube current from the separately-excited inverter circuit.

In the configuration described above, the tube current control unit stabilizes the oscillation duty ratio of the control unit at an oscillation frequency lower than a predetermined value corresponding to the actual tube current by changing the brightness control signal inputted in the control circuit to decrease the duty ratio and by shifting the feedback tube current that is feedbacked from the separately-excited inverter circuit to the high current side. With this configuration, because the oscillation duty ratio decreases, the tube current decreases and the brightness of the electric discharge lamps decreases, resulting in reducing the electric power wasted in the electric discharge lamps and realizing the power saving. Furthermore, because the feedback tube current feedbacked from the secondary side to the control circuit is shifted to a value lower than the value corresponding to the tube current that actually flows in the electric discharge lamps, the oscillation duty ratio decreases and the tube current stabilizes at a current lower than the tube current corresponding to the brightness control signal.

More specifically, the tube current control unit not only decreases the brightness of the electric discharge lamp when the backlight is not necessary to light, reduces the power to be wasted, and realizes the electric power saving, but also does not impair the user's convenience, because it does not completely turn off the electric discharge lamps remaining under the state that the user can observe a message indicating that no video signal is input. In addition, because it does not completely stop the oscillation of the inverter circuit, it can resume the state in which the backlight is lit at the normal brightness from the power saving state in a short time. This contributes also to the user's convenience.

The liquid crystal display apparatus is allowed to take a configuration that includes a resistor to split the tube current for the ground, and shifts the feedback tube current to the high current side by changing the resistance value of the resistor. That is to say, the control of the feedback tube current to be feedbacked can be easily configured.

The liquid crystal display apparatus is allowed to take a configuration that the resistor is composed of a plurality of resistors that are parallely connected with each other, and at least one of the resistors includes a switching circuit that can select whether or not to split and flow the tube current, and the tube current control unit shifts the feedback tube current to the high current side by switching the switching circuit. That is to say, the control of the feedback tube current to be feedbacked can be realized with a simple configuration as mentioned above.

The liquid crystal display apparatus is allowed to take a configuration that the resistor is composed of a plurality of resistors that are connected in series, includes a switching circuit that bypasses at least one of the plural resistors, and the tube current control unit shifts the feedback tube current to the high current side by switching the switching circuit. That is to say, the control of the feedback tube current to be feedbacked can be realized with a simple configuration as mentioned above.

As an example of taking the liquid crystal display apparatus in a more concrete form, a liquid crystal television, comprising: a separately-excited inverter circuit that includes a control circuit that changes an oscillation duty ratio of secondary voltage of the separately excited inverter circuit so that a feedback tube current feedbacked from a secondary side of the separately-excited inverter circuit becomes a predetermined value corresponding to a brightness control signal that is input to the separately-excited inverter; a plurality of electric discharge lamps that are activated by an AC voltage generated by the separately-excited inverter circuit; a tuner that extracts a video signal from received television broadcast signals and outputs the video signal; an external input terminal capable of inputting video signals; a video processing unit that extracts a synchronizing signal from the video signal input from either one of the tuner and the external input terminal, outputs the synchronizing signal, and generates a video signal having a number of pixels corresponding to a number of pixels of the liquid crystal panel; an on screen display (OSD) processing unit that superimposes an on-screen display signal on the video signal; a driving circuit that generates a drive signal from the video signal input from the video processing unit; a liquid crystal panel configured so that each liquid crystal cell is driven by the drive signal, the lights of the electric discharge lamps are illuminated from the back surface of the liquid crystal panel, and an image is displayed on screen; and a microcomputer that inputs the brightness control signal in the control circuit, and causes the OSD processing unit to display a message indicating that no video signal is input when there is no video signal that is input.

In a liquid crystal television, the inverter circuit, comprises: a first secondary winding that is coupled with one cold-cathode tube at an end of the first secondary winding, with the first secondary winding applying a voltage to the cold-cathode tube; a second secondary winding that is coupled with one cold-cathode tube at an end of the second secondary winding, with the second secondary winding applying a voltage having a substantially similar phase as that of the voltage of the first secondary winding to the cold-cathode tube; a first tube current output circuit that is coupled with another end of the first secondary winding, generates the feedback tube current from a positive directional tube current that is generated in the secondary side of the inverter, and outputs the feedback tube current; a second tube current output circuit that is coupled with another end of the second secondary winding, generates the feedback tube current from a negative directional tube current that is generated in the secondary side of the inverter, and outputs the feedback tube current; an oscillator circuit that generates an oscillation frequency signal on receiving a command signal; and a tube current decision circuit that determines if the value of the feedback tube current is greater than or equal to a predetermined value when the feedback tube current is inputted from the first tube current output circuit and the second tube current output circuit, and outputs the command signal to the oscillator circuit when the feedback tube current of greater than or equal to a predetermined value is inputted, and stop the command signal when the feedback tube current of less than a predetermined value is inputted.
Further in the liquid crystal television, the first and second tube current output circuits include a diode to rectify the current that is input from another ends; a capacitor to smooth the current; a plurality of resistors that are coupled in series to split a part of the smoothed current for the ground; a terminal to output the remaining smoothed current excluding a part of the smoothed current to the tube current decision circuit; and a bypass transistor that can bypass at least one of the plural resistors.
Still further in the liquid crystal television, the microcomputer decides the existence of a video signal input from the external input terminal out of at least one of, the existence of a switching of the video signal input source, the existence of the synchronizing signal output from the video processing unit, and the existence of the OSD display indicating that no video signal is input, and determines if a user is in a state of viewing or listening from the existence of an operation input from the user.
Yet further in the liquid crystal television, the microcomputer, on deciding that the video signal input from the external input terminal does not exist, a user does not view nor listen, and the OSD display indicates that no video signal is input, changes the brightness control signal so to decrease the duty ratio, raises the feedback tube current by turning on the bypass transistor so to bypass at least one of the resistors, and stabilizes the oscillation duty ratio at an oscillation frequency lower than a predetermined value corresponding to the tube current.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is a block diagram of the liquid crystal television according to the present invention.

FIG. 2 is a block diagram of the inverter circuit used in the present invention.

FIG. 3 is a circuit drawing of the tube current output circuit.

FIG. 4 is a circuit drawing of the tube current decision circuit.

FIG. 5 is a flowchart of the tube current control processing.

FIG. 6 is a circuit drawing related to a modified example of the tube current output circuit.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers.

Hereinafter, a preferred embodiment of the present invention will be explained in detail following the items described below with reference to the accompanying drawings.

(1) Configuration of a liquid crystal television apparatus
(2) Configuration of an inverter circuit
(3) Tube current feedback circuit
(4) Tube current control processing
(5) A modified example of the tube current feedback circuit

### (6) Summary

### (1) CONFIGURATION OF A LIQUID CRYSTAL TELEVISION APPARATUS

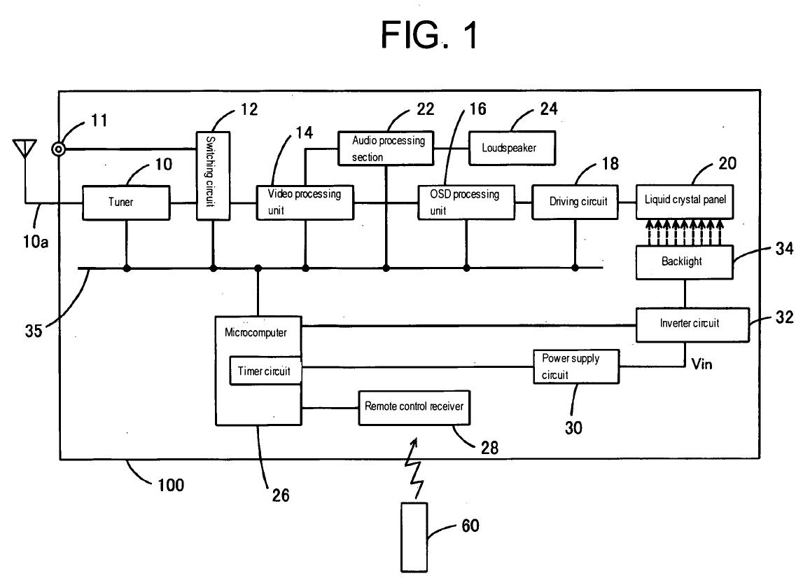

FIG. 1 is a block diagram of a liquid crystal television apparatus. In this figure, a liquid crystal television 100 as a liquid crystal display apparatus converts a video signal inputted, for example, from a tuner or an external input terminal into a drive signal, drives liquid crystal cells in a liquid crystal panel using the drive signal, illuminates the liquid crystal panel from the back surface with a backlight, and displays an on-screen image. In addition, in this figure, parts that are not directly related with the present invention are abbreviated for clarity.

As shown in FIG. 1, the liquid crystal television 100 mainly includes a tuner 10, a switching circuit 12, a video processing unit 14, an audio processing unit 22, a microcomputer 26, a liquid crystal panel 20, a loudspeaker 24, an OSD processing unit 16, a remote control receiver 28 that receives a remote control signal transmitted by a remote controller 60, backlight 34 that illuminates a light from the back surface of the liquid crystal panel 20, and an inverter circuit 32 that supplies a drive voltage to the cold-cathode tube constituting the backlight 34.

In the circuits of this liquid crystal television 100, an IIC bus 35, which is a versatile serial communication bus, is provided. All units 10, 11, 12, 14, 16, 18, 22, and 26 connected to the IIC bus 35 are constructed so that they transmit and receive data with each other following a predetermined communication protocol.

In the configuration described above, the tuner 10 receives television broadcast signals with a desired oscillation frequency corresponding to a television broadcast band through an antenna 10a by the control of the microcomputer 26, selects only the desired signal from these television broadcast signals, amplifies the high oscillation frequency signal, converts it into an intermediate oscillation frequency signal, and output it. In addition, the liquid crystal television 100 includes an external input terminal 11 through which it can input a video signal and an audio signal from a connected external input device. In the present embodiment, the tuner and the external input terminal 11 correspond to the video signal input sources, and the video signal inputted from these sources include a synchronizing signal.

The intermediate oscillation frequency signal outputted from the tuner 10, and the video and audio signals that are input from the external input terminal 11 are input in the switching circuit 12. This switching circuit 12 outputs either one of the signals that are input from tuner 10 and the external input terminal 11.

The video processing unit 14, on receiving the intermediate oscillation frequency signal outputted from the tuner 10, digitizes the intermediate oscillation frequency signal according to the input signal level, applies various kinds of signal processing to the intermediate oscillation frequency signal, and restore the video signal displayed with such colors as red, green, and blue (RGB signal), synchronizing signal, and audio signal. In the same way, the video processing unit 14 restores the video and audio signals that are output from the external input terminal 11, the RGB signal, synchronizing signal, and the audio signal.

The video processing unit 14 performs the scaling processing for the restored RGB signal in accordance with the pixel size (aspect ratio, m:n) of the liquid crystal panel 20, generates the one-screen image data to be displayed on the liquid crystal panel 20, and outputs the generated image data to the OSD processing unit 16. The video processing unit 14 performs the predetermined signal processing also for the restored synchronizing signal, and outputs it to the microcomputer 26. Further for the restored audio signal is applied the processing by the audio processing unit 22 and then to be output to the loudspeaker 24.

The OSD processing unit 16 can perform such processings as to superimpose an on-screen display signal (OSD signal) on the image data inputted from the video processing unit 14 thereby to display a screen image with a predetermined still image superimposed thereon, or to display a predetermined still image in place of the screen image. More specifically, the OSD processing unit 16, on receiving such data as character information from the microcomputer 26, creates a still image based on the data, superimposes the created still image on the image data, and outputs the image data with OSD signal superimposed thereon to the liquid crystal panel 20. Needless to say, when there is no data input such as character information from the microcomputer 26, the image data being input from the video processing unit 14 are directly output to the driving circuit 18.

The driving circuit 18 to drive each pixel generates a drive signal to control the aperture ratio of each display cell of the liquid crystal panel 20 based on the image data that are output from the OSD processing unit 16. This drive signal is used for driving each display cell, and causes the liquid crystal panel 20 to display on-screen image by transmitting the lights illuminated from the backlight 34 in the back surface onto the front surface.

The inverter circuit 32, on receiving a DC voltage from the power supply circuit 30, converts the DC voltage supplied from this power supply circuit into the high-voltage AC voltage, and supplies the AC voltage as the drive signal to the backlight 34. Note that this power supply circuit 30 gets the (AC) power supply voltage from the external commercial power source or other power sources, converts the voltage from AC to DC as necessary, and supplies the converted power supply voltage to all the circuits of the liquid crystal television apparatus such as the microcomputer 26 and the inverter circuit 32.

The backlight 34, which has plural fluorescent tubes as electric discharge lamps, is a light source to illuminate the liquid crystal panel 20 from the back surface. The backlight 34, which is activated by a high voltage supplied from the inverter circuit 32, illuminates the liquid crystal panel 20 from the back side. In the present embodiment, a cold-cathode tube is used for the backlight.

The microcomputer 26 is connected to every unit constituting the liquid crystal television 100; and the CPU as a component inside the microcomputer 26 controls the whole liquid crystal television 100 following the programs written in the ROM and RAM, components of the microcomputer 26. In addition, the microcomputer 26 has a built-in timer circuit, and gets clock signals that the timer circuit generates. The CPU, ROM, and RAM are not shown in the figure.

The remote controller 60 has plural keys to accept operations and a remote control signal transmission circuit to transmit a remote control signal to the remote control receiver 28. The remote controller 60 transmits a remote control signal according to the operation of the plural keys in a predetermined format. For example, when the remote controller 60 is operated to receive a desired channel, the corresponding remote control signal is transmitted from the remote control signal transmitter. Then, the microcomputer 26 is inputted a voltage signal from the remote control receiver 28, detects the corresponding key operation by the CPU control to accept an operation input from the remote controller 60, and transmits an oscillation frequency data to the tuner 10 so as to receive the corresponding channel.

Further, the video processing unit 14 supplies synchronizing signals (a horizontal synchronizing signal and a vertical synchronizing signal) to the microcomputer 26. Specifically, on receiving a video signal from the external input terminal 11 or the tuner 10, the video processing unit 14 extracts the synchronizing signals and supplies them to the microcomputer 26. On the other hand, the video processing unit 14 does not output the synchronizing signals to the microcomputer 26 while no video signal is inputted. The microcomputer 26 decides whether or not the synchronizing signals are supplied using tube current processing to be described later. Also, when a predetermined time has passed after the synchronizing signals were not input, the microcomputer 26 make the OSD processing unit 16 perform the OSD display indicating that no video signal is inputted.

### (2) CONFIGURATION OF THE INVERTER CIRCUIT

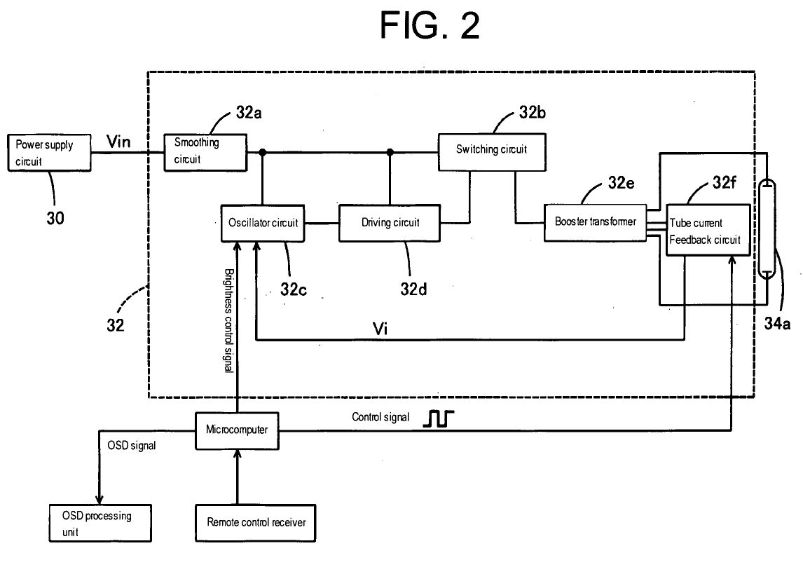

FIG. 2 is a block diagram of the inverter circuit 32. The inverter circuit according to the present invention, which is a separately-excited inverter circuit, alternately applies a voltage reversed with each other to a booster transformer using the switching circuit that is controlled by the control circuit so as to generate an AC voltage in the secondary side of the booster transformer. As shown in FIG. 2, the inverter circuit 32 is compose of a smoothing circuit 32a, the switching circuit 32b, the oscillator circuit 32c, the driving circuit 32d, the booster transformer 32e, and the feedback circuit 32f. The inverter circuit 32 is driven by a DC voltage Vin that is inputted from the power supply circuit 30, to generate an AC current for lighting the cold-cathode lamp.

The inverter circuit 32, on receiving the AC voltage Vin at the switching circuit 32b through the smoothing circuit 32b, converts the AC voltage into an DC voltage with a desired oscillation frequency by switching the switching device, and generates a secondary voltage through the booster transformer 32e. This secondary voltage is supplied to the cold-cathode tube 34a (electric discharge lamp). The cold-cathode tube 34a constitutes a part of backlight 34 (FIG. 2 shows only one cold-cathode tube 34a as an example, normally, plural cold-cathode tubes are provided), and the number of the booster transformers increases according to the number of the cold-cathode tubes. Incidentally, the number of the switching circuits and the feedback circuits increases or decreases in accordance with the number of the cold-cathode tubes. The switching of the switching circuit 32b is controlled by the control circuit composed of the oscillator circuit 32c and the driving circuit 32d.

The switching circuit 32b includes a separately-excited inverter circuit where four MOS-FET Q11, Q12, Q21, and Q22 are full-bridge connected therebetween. This full-bridge connection is formed by the combination of a half-bridge connection of the pair of MOS-FET Q11 and Q12, and a half-bridge connection of the pair of MOS-FET Q21 and Q22. In the present embodiment, although MOS-FETs are used in the full-bridge circuit, other transistor devices may be used for the full-bridge circuit.

The half-bridge connection of the pair of MOS-FET Q11 and Q12 is formed by connecting the drain of MOS-FET Q11 to the line of a smoothing voltage Ein that is outputted from the smoothing circuit 32a, by connecting the source of MOS-FET Q11 to the drain of MOS-FET Q12, and by connecting the source of MOS-FET Q12 to the ground. Similarly, the half-bridge connection of the pair of MOS-FET Q21 and Q22 is formed by connecting the drain of MOS-FET Q21 to the line of the smoothing voltage Ein, by connecting the source of MOS-FET Q21 to the drain of MOS-FET Q22, and by connecting the source of MOS-FET Q22 to the ground. In addition, the connection point (switching output point) of the source and drain of MOS-FET Q11 and Q12 is connected to one end of the primary winding of the booster transformer 32e, and the other end of the primary winding of the booster transformer 32e is connected to the connection point (switching output point) of the source and drain of MOS-FET Q21 and Q22.

The oscillator circuit 32c receives a command signal to direct to turn on or off the oscillation and a brightness control signal to direct the duty ratio of the oscillation from the microcomputer 26. On receiving the command signal to direct to turn on the oscillation and the brightness control signal, the oscillator circuit 32c generates an oscillation frequency signal of the duty ratio corresponding to the brightness control signal at a predetermined oscillation frequency, and outputs the oscillation frequency signal to the driving circuit 32d.

The driving circuit 32d outputs a switching drive signal to the gates of MOS-FET Q11, Q12, Q21, and Q22 to control so that MOS-FET Q11 and Q12 turn on or off at the same timing and that MOS-FET Q21 and Q22 turn on or off at the same timing. That is to say, MOS-FET Q11 and Q12 turn on or off alternately, and MOS-FET Q21 and Q22 turn on or off alternately. These oscillator circuit 32c and the driving circuit 32d constitute the control circuit.

Accompanied with the on/off operation of the switching circuit 32b, a reversing voltage at a predetermined oscillation frequency is applied to the primary winding of the booster transformer 32e, and an AC secondary voltage is generated at the secondary winding of the booster transformer 32e, which causes the cold-cathode tube 34a to be lit.

The feedback circuit 32f, which monitors the secondary voltage and secondary current and feedbacks the monitored results to the control circuit, is provided in the secondary side of the booster transformer 32e. The feedback circuit 32f, for example, outputs the feedback voltage and the feedback current according to the levels of fluctuations of the secondary voltage E2 (for example, the tube voltage) and the secondary current I2 (for example, the tube current) to the oscillator circuit 32c. Note that as an example of the feedback circuit to feedback the tube voltage, used is a circuit to divide the secondary voltage that is outputted from the secondary winding of the booster transformer 32e to decrease the voltage into a predetermined fraction by means of a dividing capacitor. This divided voltage is outputted as the feedback voltage. In addition, as an example of the feedback circuit to feedback the tube current, used is a circuit to rectify the secondary current of the booster transformer 32e by means of a diode and to remove the pulsating current from the rectified current by means of a capacitor.

The oscillator circuit 32c changes the secondary voltage and the secondary current by adjusting the duty ratio of the oscillation frequency signal based on the feedback voltage and the feedback tube current. For example, the oscillator circuit 32c, when the secondary voltage E2 and the secondary current I2 increase, controls to decrease the secondary voltage E2 and the secondary current I2 that are generated in the secondary winding by decreasing the duty ratio of the oscillation frequency. Conversely, the oscillator circuit 32c, when the secondary voltage E2 and the secondary current I2 decrease, controls to increase the secondary voltage E2 and the secondary current I2 that are generated in the secondary winding by increasing the duty ratio of the oscillation frequency. That is to say, the oscillator circuit 32c performs a constant voltage control that adjusts the oscillation frequency signal so as to remove the up and down movement of the feedback voltage and feedback current.

### (3) TUBE CURRENT FEEDBACK CIRCUIT

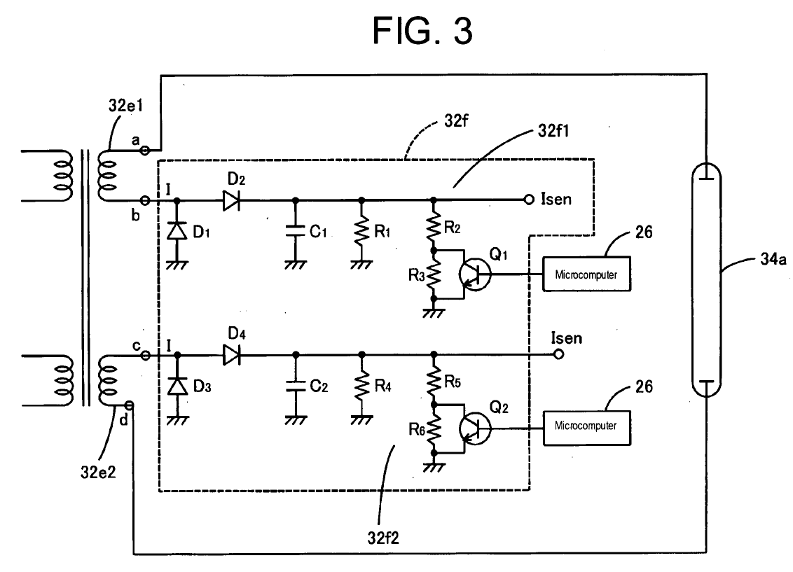

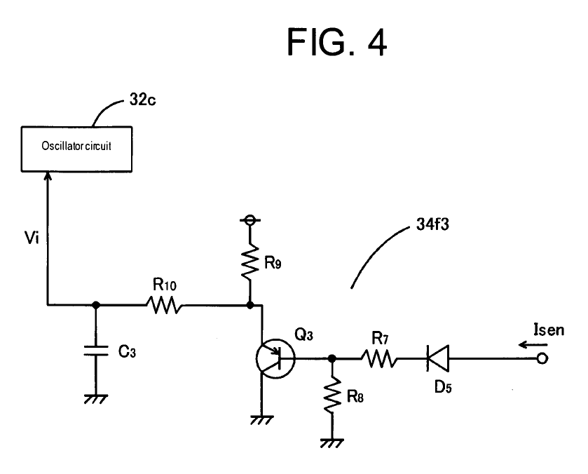

FIG. 3 shows the tube current output circuits 32f1 and 32f2, and FIG. 4 shows the tube current decision circuit 32f3. The tube current output circuit generates the feedback tube current Isen from the tube current I, which is generated at the secondary side of the inverter circuit 32, and outputs this feedback tube current Isen to the tube current decision circuit. The tube current decision circuit decides whether or not the feedback tube current is greater than or equal to a predetermined value. The tube current decision circuit, on deciding that the feedback tube current Isen of greater than or equal to a predetermined value is entered, outputs a high voltage (H) to the oscillator circuit, while on deciding that the feedback tube current Isen of less than a predetermined value is entered, outputs a low voltage (L) to the oscillator circuit. That is to say, the tube current output circuit and the tube current decision circuit constitute the tube current feedback circuit 32f that feedbacks the tube current to the oscillator circuit.

First, the connection between the tube current feedback circuit 32f and the booster transformer 32e will be described. In FIG. 3, the booster transformer includes two secondary windings 32e1 and 32e2 for one cold-cathode tube 34a. For the secondary winding 32e1, the terminal a is connected to one end of the cold-cathode tube 34a, terminal b is connected to the tube current output circuit 32f1. Similarly, for the secondary winding 32e2, the terminal d is connected to the other end of the cold-cathode tube 34a, terminal c is connected to the tube current output circuit 32f2. That is to say, the cold-cathode tube 34a is connected to one end of the secondary winding 32e1 and one end of the secondary winding 32e2. A voltage from the secondary winding 32e1 and a voltage from the secondary winding 32e2 are applied to the cold-cathode tube 34a connected in this way at the same phase. In other words, it is selected so that the voltage generated between terminals a and d and the voltage generated between terminals d and c become in opposite phase with each other.

The tube current output circuit 32f1 (the first tube current detection circuit) shown in FIG. 3 is composed of diodes D1 and D2 for rectifying current, a capacitor C 1 for removing pulsating current, resistors R1, R1, R3 for setting the feedback tube current, and an NPN type transistor Q1 (bypass transistor) for changing the feedback tube current. In this configuration, the cathode of the diode D1 and the anode of the diode D2 are both connected to the terminal b of the secondary winding 32e1. In addition, the anode of the diode D1 is grounded, and on the other hand, the capacitor C1 and the resistors R1 and R2 are connected to the output line that is extended from the diode D2.

Similarly, the tube current output circuit 32f2 (the second tube current detection circuit) is composed of diodes D3 and D4 for rectifing current, a capacitor C2 for removing pulsating current, resistors R4, R5, R6 for setting the feedback tube current, and an NPN type transistor Q2 (bypass transistor) for changing the feedback tube current. In this configuration, the cathode of the diode D3 and the anode of the diode D4 are both connected to the terminal c of the secondary winding 32e2. And, the anode of the diode D3 is grounded, and on the other hand, the capacitor C2 and the resistors R4 and R5 are connected to the output line extending from the diode D4.

As mentioned above, the tube current output circuit 32f1 and the tube current output circuit 32f2 have the same circuit configuration wherein used are the same devices have the same constants correspond thereto. More specifically, the tube current output circuit 32f1 generates the feedback tube current Isen from the tube current I in one direction (for example, positive direction) and outputs it, while the tube current output circuit 32f2 generates the feedback tube current Isen from the tube current I in the reverse direction (for example, negative direction) and outputs it, i.e., if the feedback tube currents Isen from these tube current output circuits 32f1 and 32f2 are combined, a full-wave rectified feedback tube current is outputted.

With the configuration of the tube current output circuits 32f1 and 32f2, current flows as described below. First, when the potential difference between the terminals a and b, and the potential difference between the terminals c and d are positive, the current supplied from the ground to the diode D1 flows in the order of the terminal b, terminal a, cold-cathode tube 34a, terminal d, terminal c, and the diode D4, and is outputted as the feedback tube current Isen. On the other hand, when the potential difference between the terminals a and b, and the potential difference between the terminals c and d are negative, the current supplied from the ground to the diode D3 flows in the order of the terminal c, terminal d, cold-cathode tube 34a, terminal a, terminal b, and the diode D2, and is outputted as the feedback tube current Isen. That is to say, the feedback tube current Isen is outputted alternately from the tube current output circuit 32f1 and the tube current output circuit 32f2. In addition, the feedback tube current Isen is outputted as a current with a positive value.

In the tube current output circuit as mentioned above, it is possible to change the value of the feedback tube current Isen by using the resisters R1 to R6 and transistors Q1 and Q2.

First, the tube current output circuit 32f1 is configured such that: the resistor R1 is connected between the output line of the tube current output circuit 32f1 and the ground; similarly, resisters R2 and R3 are connected in series, and this serially connected feedback tube current setting resistor is connected between the output line of the tube current output circuit 32f1 and the ground; the collector of the transistor Q1 is connected between the resistors R2 and R3, and the emitter of the transistor Q1 is grounded; and the base of the transistor Q1 is connected to a predetermined port of the microcomputer 26, enabling to turn on or off the transistor Q1 by the control of the microcomputer 26.

On the other hand, the tube current output circuit 32f2 is configured such that: the resistor R4 is connected between the output line of the tube current output circuit 32f2 and the ground; similarly, resisters R5 and R6 are connected in series, and this serially connected feedback tube current setting resistor is connected between the output line of the tube current output circuit 32f2 and the ground; the collector of the transistor Q2 is connected between the resistors R5 and R6, and the emitter of the transistor Q2 is grounded; and the base of the transistor Q2 is connected to the predetermined port of the microcomputer 26, enabling to turn on or off the transistor Q2 by the control of the microcomputer 26.

When the microcomputer 26 turns on the transistors Q1 and Q2, the transistors Q1 and Q2 bypass the resistors R3 and R6, respectively. Then the current flowing through the resistor R3 and resistor R2, and the current flowing through the resistor R5 and resistor R6 increase, shifting the feedback tube current Isen to the higher current side. Conversely, the microcomputer 26 switches the transistors Q1 and Q2 from the on state to the off state, the feedback tube current Isen shifts to the lower current side.

Since the timing of the microcomputer 26 for controlling the bases of the transistors Q1 and Q2 are interlocked, it is possible to take the configuration where a control signal outputted from the same port is inputted in both transistors.

The tube current decision circuit 32f3 shown in FIG. 4 includes a backflow prevention diode D5, serially connected resistors R7 and R8, a PNP type transistor Q3 whose base is connected to the connection point of these resistors R7 and R8, a resistor R9 that connects the emitter of the transistor Q3 to the high level voltage line, a resistors R10 that connects the emitter of the transistor Q3 to the oscillator circuit 32c, and a capacitor C3 that smoothes a voltage V1 inputted in the oscillator circuit 32c.

With the configuration of this tube current decision circuit 32f3, the inputted feedback tube current Isen flows to the ground through the diode D5 and the resistors R7 and R8. On this occasion, a voltage Vsen corresponding to the feedback tube current Isen is generated at the connection point of the resistor R7 and the resistor R8. When this voltage Vsen decreases less than a predetermined value, the transistor Q3 turns on to decrease the voltage V1 inputted in the oscillator circuit 32c to a low voltage (L). On the other hand, if the voltage Vsen is greater than or equal to the predetermined value, the transistor Q3 is off, and the voltage V1 inputted in the oscillator circuit 32c is supplied from the high level voltage line, and it remains at a high voltage (H).

When the voltage V1 inputted in the oscillator circuit 32c becomes L, the oscillator circuit 32c keeps the duty ratio of the oscillation frequency at a value corresponding to the brightness control signal. On the other hand, when the voltage inputted in the oscillator circuit 32c becomes H, the oscillator circuit 32c decreases the duty ratio of the oscillation frequency to a value lower than the value corresponding to the brightness control signal, and keeps the decreased duty ratio until the voltage V1 changes to L.

Hereinafter, the operation of the tube current feedback circuit mentioned above will be explained in detail.

First, when the transistors Q1 and Q2 are turned on to shift the feedback tube current Isen to the high current side, the voltage Vsen at the connection point of the resistors R7 and R8 shifts to the high voltage side. That is to say, compared with the time before turning on the transistors Q1 and Q2, the tube current required to change the voltage V1 that is inputted in the oscillator circuit to H becomes lower, enabling to stabilize the duty ratio of the oscillation frequency signal at an oscillation frequency lower than a predetermined value corresponding to the actual tube current. Therefore, it becomes possible to control the tube current I that is generated at the secondary winding of the inverter circuit 32 at a low value.

Next, when the transistors Q1 and Q2 are turned off to shift the feedback tube current Isen to the low current side, the voltage Vsen at the connection point of the resistors R7 and R8 shifts to the constant voltage side. That is to say, compared with the time when the transistors Q1 and Q2 were on, the tube current required to change the voltage V1 that is inputted in the oscillator circuit to H becomes higher, stabilizing the tube current I that is generated at the secondary winding of the inverter circuit 32 at a high value.

### (4) TUBE CURRENT CONTROL PROCESSING

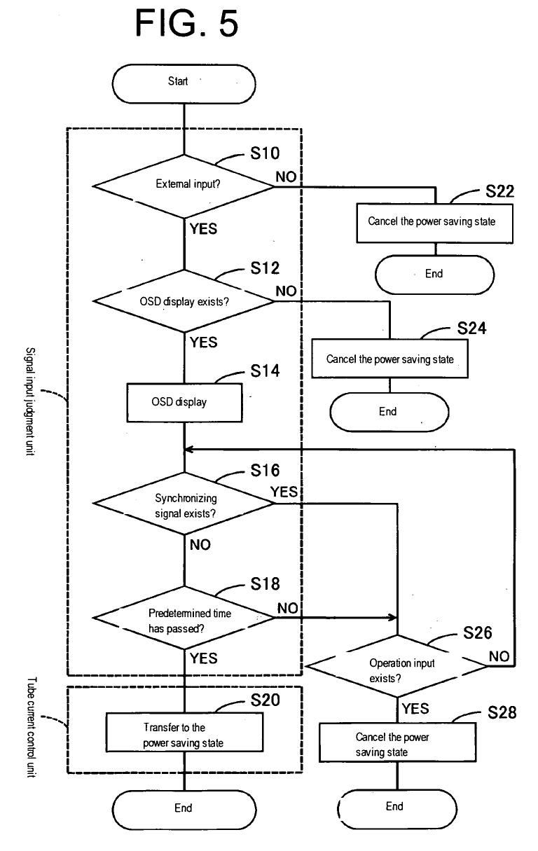

FIG. 5 is a flowchart showing the processing that the microcomputer controls the tube current. This control processing of the tube current is performed by the control of the feedback tube current and the control of the brightness control signal. This processing is repeatedly performed when the liquid crystal television 100 is turned on.

When the processing starts, the process decides the input source of the present video signal at S10. That is to say, the process decides whether the system is in the state to process a video signal inputted from the tuner 10, or the system is in the state to process a video signal inputted from the external terminal 11. This decision can also be done by whether or not the mode switching signal from the remote controller 60 is inputted. When the input source of the video signal is the external terminal, the process proceeds to step S12 as a result of satisfying the condition. On the other hand, when the input source of the video signal is the tuner, the process proceeds to step S22 as a result of not satisfying the condition. In step S22, if the present state is the power saving state, the process cancels this power saving state to return it to the normal state and finishes the tube current control processing.

In step S12, the process decides whether or not the OSD display is performed. For example, the process decides whether or not the OSD display such as “Video 1” or “No Signal” is executed. That is to say, if a video signal is inputted from the external terminal, such an OSD display is not performed. This decision can be done whether or not the microcomputer 26 directs the OSD processing unit 16 to perform an OSD display. When the OSD display is performed, the process proceeds to step S14 as a result of satisfying the condition, continues or starts the OSD display, and proceeds to step S16. On the other hand, while the OSD display is not performed, the process proceeds to step S24 as a result of not satisfying the condition, cancels the power saving state to return it to the normal state, and finishes the tube current control processing.

In step S16, the process decides whether or not a synchronizing signal is inputted. On this occasion, the horizontal signal is more preferable than the vertical signal as a synchronizing signal to decide, because the width of inserting audio signals of the horizontal signal is shorter and the amount of those are larger than those of the vertical signal. If a synchronizing signal is inputted, the process proceeds to step S18 as a result of satisfying the condition, and if a synchronizing signal is not input, the process proceeds to step S26 as a result of not satisfying the condition.

In step S26, the process decides whether or not an operation input is performed. The existence or nonexistence of this operation input can be decided by the existence or nonexistence of such as a remote control signal inputted from the remote control receiver 25 showing the remote control operation, or, although abbreviated in the figure, an operation signal inputted from the operation panel of the liquid crystal television 100, for example. If an operation input is performed, the process proceeds to step S28 as a result of satisfying the condition, cancels the power saving state to return it to the normal state, and finishes the tube current control processing. On the other hand, if an operation input is not performed, the process repeats the processing from step S16 as a result of not satisfying the condition.

In step S18, the process decides whether or not a predetermined time has passed. This predetermined time may be a time since the tube current control processing has started or a time during which no synchronizing signal is inputted continuously. When a predetermined time has passed, the process proceeds to step S20 as a result of satisfying the condition; and while a predetermined time has not passed, the process repeats the processing from step S26 as a result of not satisfying the condition.

In step S20, the process transfers the system into the power saving state. More specifically, the process performs at least one of the processing to shift the feedback tube current Isen to the high current side (the control of the feedback tube current) and the processing to change the brightness control signal to make it oscillate at a low duty ratio (the control of the brightness control signal). Controlling the feedback tube current makes it possible to reduce the power consumption by about a few tens percent compared with that in the normal state. Furthermore, controlling also the brightness control signal reduces the power consumption by about a half compared with that in the normal state.

As mentioned above, the microcomputer 26 that performs the processing of steps S10 to S18 configures the signal input decision unit, and the microcomputer 26 that performs the processing of step S20 configures the tube current control unit.

### (5) A MODIFIED EXAMPLE OF THE TUBE CURRENT FEEDBACK CIRCUIT

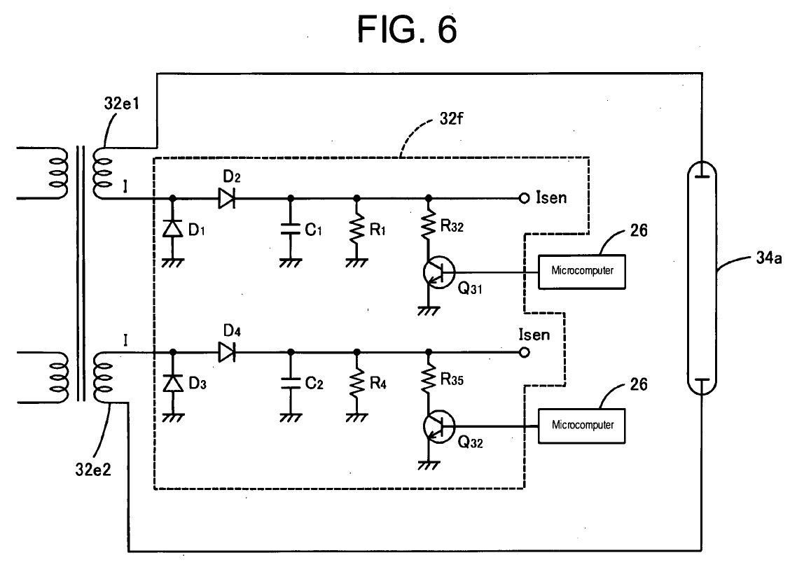

The tube current feedback circuit mentioned above may also take a form of a modified example as shown in FIG. 6. This modified example uses a resistor R32 and a transistor Q31 for setting the feedback tube current in place of the resistors R2 and R3 and the transistor Q1 in the above-described embodiment, and also uses a resistor R35 and a transistor Q32 in place of the resistors R5 and R6 and the transistor Q2.

That is to say, this modified example connects one end of the resistor R32 to the collector of the transistor Q31, connects the other end of the resistor R32 to the output line of the feedback tube current Isen, and grounds the emitter of the transistor Q31. On this occasion, the microcomputer 26 can turn on or off the base of the transistor Q31, just like in the embodiment described above. This modified example also connects one end of the resistor R35 to the collector of the transistor Q32, connects the other end of the resistor R35 to the output line of the feedback tube current Isen, and grounds the emitter of the transistor Q32. On this occasion, the microcomputer 26 can turn on or off the base of the transistor Q32, just like in the embodiment described above.

When the transistors Q31 and Q32 are turned on, the resistor R1 is connected to the resistor R32 in parallel, and the resistor R4 is connected to the resistor R35 in parallel. And a part of the tube current I flows through the resisters R32 and R35, respectively, resulting in relatively decreasing the feedback tube current. On the other hand, when the transistors Q31 and Q32 are turned off, the tube current I does not flow through the resisters R32 and R35, respectively, resulting in relatively increasing the feedback tube current Isen. That is to say, the present modified example normally turns on the transistors Q31 and Q32, and when it performs the power saving, it turns off the transistors Q31 and Q32.

With the configuration described above, the microcomputer can shift the feedback tube current Isen by controlling the on/off of the transistors Q31 and Q32.

### (6) CONCLUSION

The microcomputer 26, on detecting that no video signal is inputted, decreases the duty ratio of the brightness control signal inputted in the control circuit 32c and shifts the feedback tube current Isen that is feedbacked from the tube current feedback circuit 32f to a high current side, and thereby stabilizes the oscillation duty ratio of the control circuit 32c at an oscillation frequency lower than a predetermined value corresponding to the actual tube current I. This makes it possible to control the lighting of the backlight during the time while no video signal is inputted so as to reduce the power consumption while informing the user a message that the lighting is controlled, leading to energy saving without impairing the user's convenience.

Although in the preferred embodiment described above, a liquid crystal television is cited as an example, the present invention is not limited to this. If a liquid crystal display apparatus includes a backlight with electric discharge lamps, a separately-excited inverter circuit, and a panel illuminated by the light of the backlight from the back surface, various changes and modifications can be made for it as the preferred embodiment of the present invention without departing from the spirit and scope thereof.

In the preferred embodiment described above, although an explanation is made using a full-bridge circuit as the switching circuit, it is also possible to use other separately excited switching circuits such as a half-bridge circuit (a switching snubber circuit) and a push-pull circuit, for example.

In the present invention, although an explanation is made by using a configuration in which a transistor bypasses one resistor, it will be obvious that if plural transistors are used in cascade, the feedback tube current can be adjusted more finely, thereby it becomes possible to accomplish a fine brightness adjustment.

In the tube current control processing described above, although the existence or nonexistence of a video signal input is decided from all ones of the existence or nonexistence of a video signal from the external input terminal, the existence or nonexistence of an OSD display, and the existence or nonexistence of a synchronizing signal, it is possible to decide the existence or nonexistence of a video signal inputted from any one of these ones; for this reason, it is possible to configure the tube current control processing in which the existence or nonexistence of a video signal input is decided using at least only one of these ones.

Although the tube current decision circuit 32f is configured by combining a transistor with a high level voltage line, it will be obvious that any comparison circuit that can compare the voltage corresponding to the feedback tube current Isen with a predetermined voltage is allowed to use; therefore, it is also possible to employ a circuit using, for example, a comparator in configuring this circuit.

In addition, it will be obvious that the present invention is not limited to the preferred embodiment as mentioned above. It will be obvious to those skilled in the art that:

to appropriately modify the combination of the mutually replaceable components, configuration and the like, which are disclosed in the preferred embodiment described above, and to apply them to the embodiment;

to appropriately replace the mutually replaceable components, configuration, and the like, which are not disclosed in the preferred embodiment described above but heretofore known technologies, to modify the combination of them, and to apply them to the embodiment;

and to appropriately replace the components, configuration, and the like, which are not disclosed in the preferred embodiment described above but those skilled in the art can imagine as the substitutes for them based on heretofore known technologies, to modify the combination of them, and to apply them to the embodiment should be disclosed as the preferred embodiment according to the present invention.

While the invention has been particularly shown and described with respect to preferred embodiment thereof, it should be understood by those skilled in the art that the foregoing and other changes in form and detail may be made therein without departing from the sprit and scope of the invention as defined in the appended claims.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A liquid crystal display apparatus, comprising:
a separately-excited inverter circuit having a control circuit that changes an oscillation duty ratio of secondary voltage of the separately excited inverter circuit so that a feedback tube current feedbacked from a secondary side of the separately-excited inverter circuit becomes a predetermined value corresponding to a brightness control signal that is input to the separately excited inverter circuit;
a plurality of the electric discharge lamps that are activated by an AC voltage generated by the separately-excited inverter circuit;
a liquid crystal panel, with each liquid crystal cell driven by a drive signal generated from a video signal, lights of the electric discharge lamps are illuminated from the back surface of the liquid crystal panel, and an image is displayed on screen; and
a signal input decision unit that determines if a video signal is inputted and, if the signal input decision unit determines that no video signal is inputted, the signal input decision unit displays a message indicating that no video signal is input on the liquid crystal panel,
the liquid crystal display apparatus, further comprising:
a tube current control unit that stabilizes the oscillation duty ratio of the control unit at an oscillation frequency lower than a predetermined value corresponding to the tube current of an electric discharge lamp by changing the brightness control signal inputted in the control circuit, which decreases the duty ratio and by raising the feedback tube current from the separately-excited inverter circuit.

2. The liquid crystal display apparatus according to claim 1, wherein
the tube current control unit includes a resistor to split the feedback tube current for the ground, and
the tube current control unit shifts the feedback tube current to a high current side by changing the resistance value of the resistor.

3. The liquid crystal display apparatus according to claim 1, wherein
the resistor is composed of a plurality of resistors that are connected in parallel with each other;
the tube current control unit includes a switching circuit capable of selecting whether or not to split the feedback tube current to flow at least one of the plural resistors; and
the tube current control unit shifts the feedback tube current to a high current side by switching the switching circuit.

4. The liquid crystal display apparatus according to claim 1, wherein
the resistor is composed of a plurality of resistors that are connected in series;
the tube current control unit includes a switching circuit that bypass at least one of the plural resistors; and
the tube current control unit shifts the feedback tube current to a high current side by switching the switching circuit.

5. A liquid crystal television, comprising:
a separately-excited inverter circuit that includes a control circuit that changes an oscillation duty ratio of secondary voltage of the separately excited inverter circuit so that a feedback tube current feedbacked from a secondary side of the separately-excited inverter circuit becomes a predetermined value corresponding to a brightness control signal that is input to the separately-excited inverter;
a plurality of electric discharge lamps that are activated by an AC voltage generated by the separately-excited inverter circuit;
a tuner that extracts a video signal from received television broadcast signals and outputs the video signal;
an external input terminal capable of inputting video signals;
a video processing unit that extracts a synchronizing signal from the video signal input from either one of the tuner and the external input terminal, outputs the synchronizing signal, and generates a video signal having a number of pixels corresponding to a number of pixels of the liquid crystal panel;
an on screen display (OSD) processing unit that superimposes an on-screen display signal on the video signal;
a driving circuit that generates a drive signal from the video signal input from the video processing unit;
a liquid crystal panel configured so that each liquid crystal cell is driven by the drive signal, the lights of the electric discharge lamps are illuminated from the back surface of the liquid crystal panel, and an image is displayed on screen; and
a microcomputer that inputs the brightness control signal in the control circuit, and causes the OSD processing unit to display a message indicating that no video signal is input when there is no video signal that is input;
the inverter circuit, comprises:
a first secondary winding that is coupled with one cold-cathode tube at an end of the first secondary winding, with the first secondary winding applying a voltage to the cold-cathode tube;
a second secondary winding that is coupled with one cold-cathode tube at an end of the second secondary winding, with the second secondary winding applying a voltage having a substantially similar phase as that of the voltage of the first secondary winding to the cold-cathode tube;
a first tube current output circuit that is coupled with another end of the first secondary winding, generates the feedback tube current from a positive directional tube current that is generated in the secondary side of the inverter, and outputs the feedback tube current;
a second tube current output circuit that is coupled with another end of the second secondary winding, generates the feedback tube current from a negative directional tube current that is generated in the secondary side of the inverter, and outputs the feedback tube current;
an oscillator circuit that generates an oscillation frequency signal on receiving a command signal; and
a tube current decision circuit that determines if the value of the feedback tube current is greater than or equal to a predetermined value when the feedback tube current is inputted from the first tube current output circuit and the second tube current output circuit, and outputs the command signal to the oscillator circuit when the feedback tube current of greater than or equal to a predetermined value is inputted, and stop the command signal when the feedback tube current of less than a predetermined value is inputted,
the first and second tube current output circuits include a diode to rectify the current that is input from another ends; a capacitor to smooth the current; a plurality of resistors that are coupled in series to split a part of the smoothed current for the ground; a terminal to output the remaining smoothed current excluding a part of the smoothed current to the tube current decision circuit; and a bypass transistor that can bypass at least one of the plural resistors;
the microcomputer decides the existence of a video signal input from the external input terminal out of at least one of, the existence of a switching of the video signal input source, the existence of the synchronizing signal output from the video processing unit, and the existence of the OSD display indicating that no video signal is input, and determines if a user is in a state of viewing or listening from the existence of an operation input from the user; and
the microcomputer, on deciding that the video signal input from the external input terminal does not exist, a user does not view nor listen, and the OSD display indicates that no video signal is input, changes the brightness control signal so to decrease the duty ratio, raises the feedback tube current by turning on the bypass transistor so to bypass at least one of the resistors, and stabilizes the oscillation duty ratio at an oscillation frequency lower than a predetermined value corresponding to the tube current.
